(19) United States
(12) Patent Application Publication
(10) Pub. No.: US 2006/0273622 A1
(43) Pub. Date: Dec. 7, 2006

(54) Trailer

(76) Inventor: Jeffrey Kenneth Laird, Waratah (AU)

Correspondence Address: MICHAEL MOLINS;MOLINS & CO., SUITE 5, LEVEL 6, 139 MACQUARIE ST, SYDNEY NSW, 2000, AU

(21) Appl. No.: 11/134,434

(22) Filed: May 23, 2005

(51) Int. Cl. B60P 3/35

(52) U.S. Cl. 296/168

(57) ABSTRACT

A trailer has polymer or composite compartment carried above an “A” shaped frame. In preferred embodiments, the compartment is sealed by a co-operating rigid, removable cover. The cover may serve as either a watercraft or as a shelving unit or as both of these.

### FIELD OF THE INVENTION

The invention pertains to trailers and more particularly to a multi-purpose trailer.

### BACKGROUND OF THE INVENTION

A trailer is a vehicle that is towed by another vehicle. A conventional box trailer has a generally rectangular compartment that is suspended above an axel and a pair of wheels. A conventional box trailer adequately serves the purpose of transporting goods from one place to another behind a towing vehicle. However, a conventional box trailer can be improved by providing any one of a number of features. It can be further improved by providing capabilities hitherto unknown in the trailer art including combinations of features not generally found in conventional trailers.

### OBJECTS AND SUMMARY OF THE INVENTION

It is an object of the invention to provide a multi-purpose trailer.

In some embodiments of the invention, a polymer or composite compartment is carried above an “A” shaped frame.

In some embodiments of the invention, the compartment has aerodynamic features.

In other embodiments of the invention, the compartment is covered with a co-operating rigid cover.

In other embodiments of the invention, the cover can serve as either a watercraft or as a shelving unit or as both of these.

### BRIEF DESCRIPTION OF THE DRAWING FIGURES

FIG. 1(a) is a side elevation of a trailer made in accordance with the teachings of the present invention;

FIG. 1(b) is a bottom plan view of the trailer depicted in FIG. 1(a);

FIG. 1(c) is a top plan view of the trailer depicted in FIG. 1(a);

FIG. 1(d) is a front elevation of the trailer depicted in FIG. 1(a);

FIG. 1(e) is a rear elevation of the trailer depicted in FIG. 1(a);

FIG. 2 is a side elevation of a trailer with a rigid cover, in an open position;

FIG. 3 is a perspective view of a trailer having a cover in the closed position;

FIG. 4 is a perspective view of a trailer having a cover in the open position;

FIG. 5 is a side elevation view of a trailer that has been up-ended so as to rest stably on rear surfaces of the compartment and cover;

FIG. 6 is an exploded perspective view of a trailer and cover;

FIG. 7 is an inverted exploded perspective view of the compartment, frame and fenders;

FIG. 8 is a perspective view of the cover, including its removable shelves;

FIG. 9 is an exploded perspective view of the cover indicating how shelves are inserted and removed;

FIG. 10 is a perspective view of the cover with seats installed; and

FIG. 11 is a perspective view of the cover illustrating the installation and removal of seats.

### BEST MODE AND OTHER EMBODIMENTS OF THE INVENTION

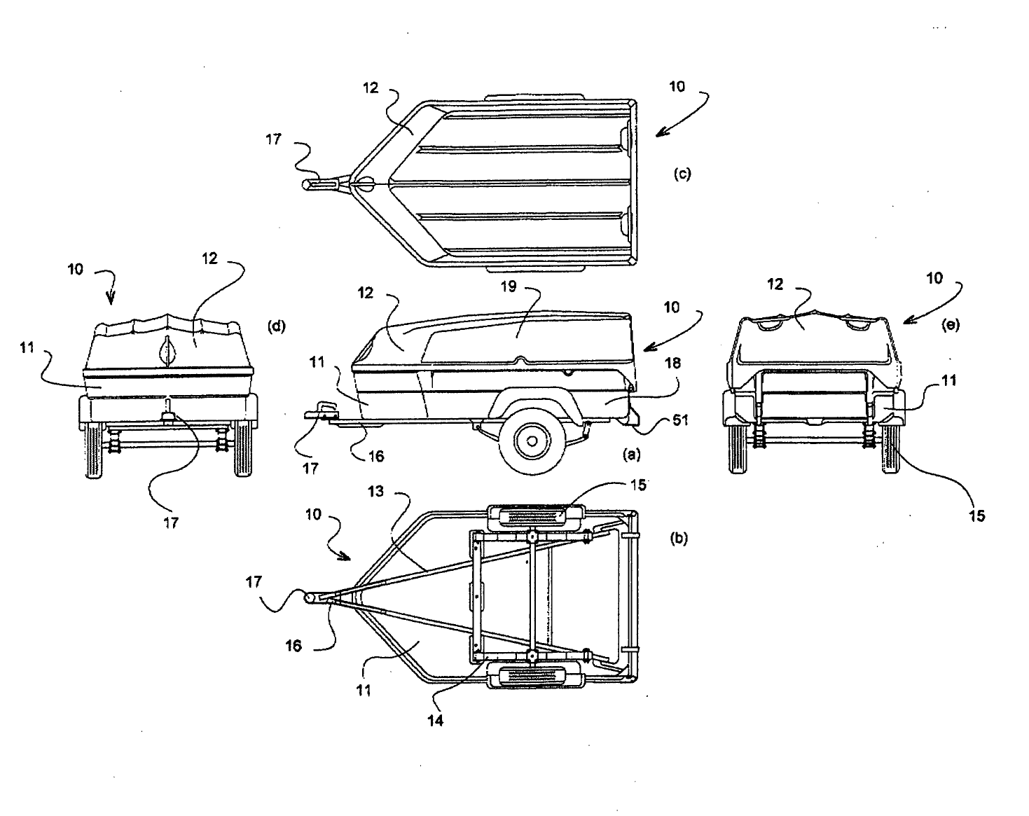

As shown in FIG. 1(a)-1(e) a trailer 10 comprises a compartment 11 that is sealed by a co-operating ridged cover 12. As shown in these figures, the compartment 11 is attached to a metal “A” shaped frame 13. The frame 13 has attached to it certain suspension components 14 that support a pair of wheels 15. The apex 16 of the “A” shaped frame carries the coupling mechanism 17 that is appropriate for the towing vehicle. The compartment 11 and cover 12 may be fabricated from a polymer or polymer composite, reinforced by metal tubes as required. As illustrated the compartment and cover 11, 12 have forward prow-like portions that provide potential aerodynamic efficiency when towed in the closed position. In addition the cover 12 may have hydrodynamic features, as will be explained.

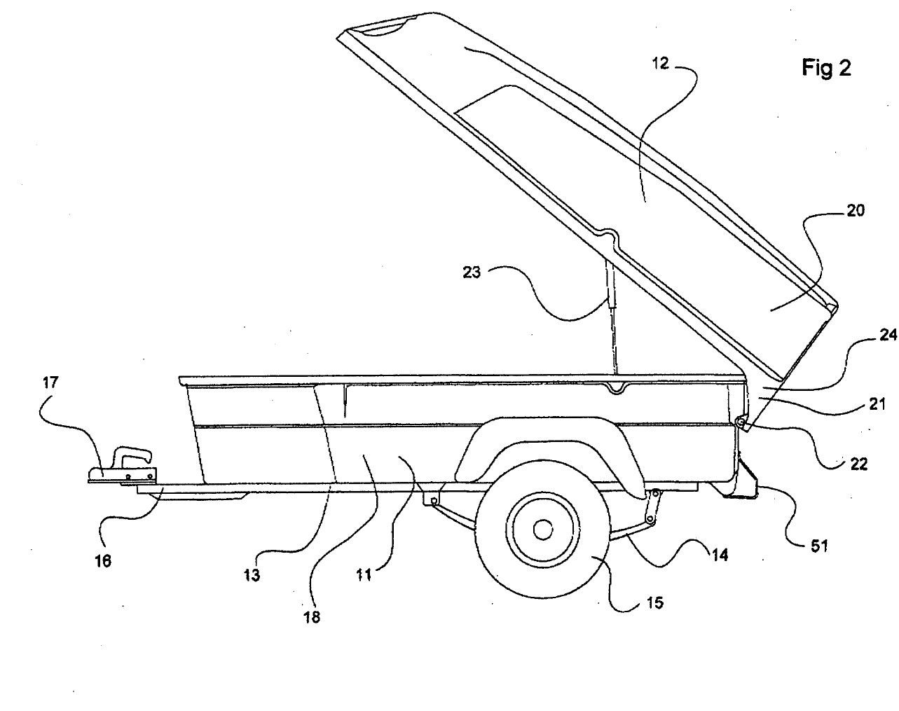

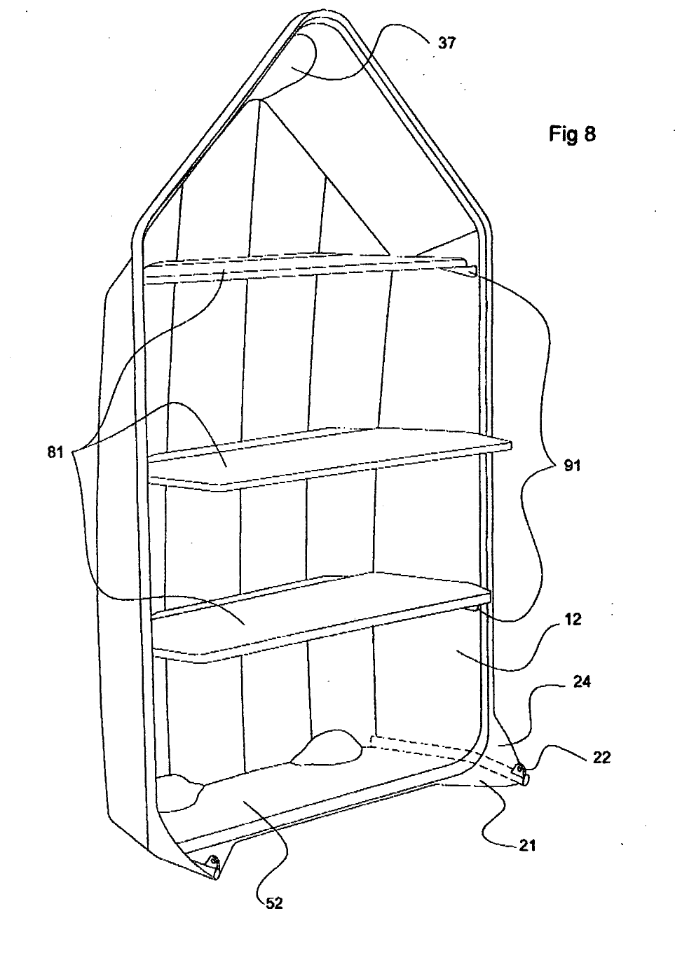

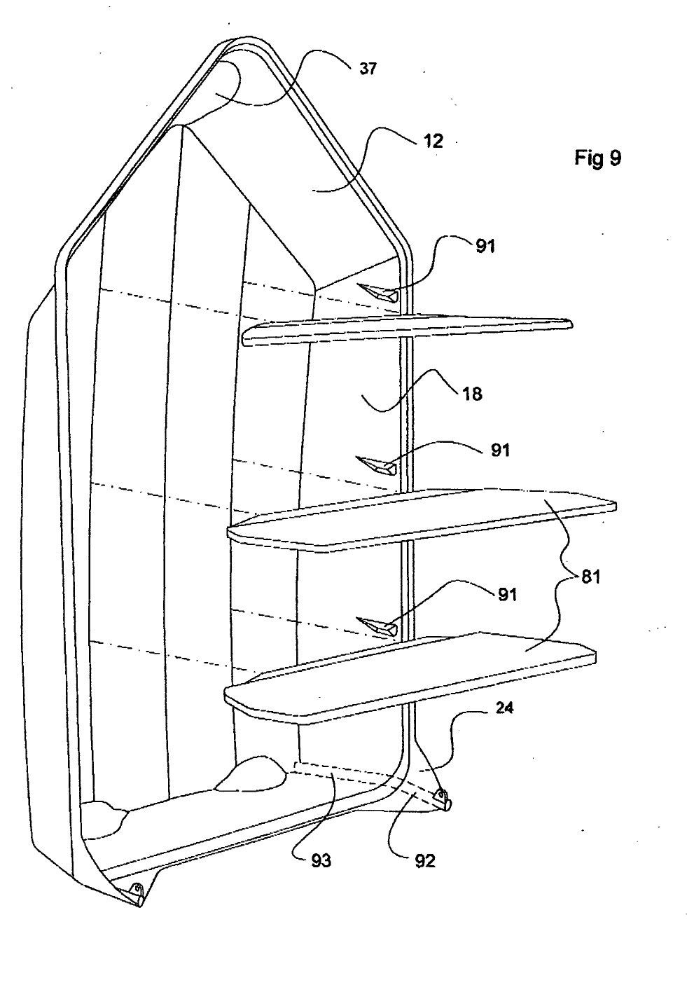

As shown in FIG. 2, the rear portion 20 of the cover 12 further comprises a pair of rear located extensions or brackets 21 that carry hinge components 22. Lateral as well as rear facing gussets 24, 62 may be provided in the area of the cover's hinge components 22 for added strength. The hinge components 22 allow the cover 12 to pivot with respect to the compartment 11. This pivoting motion may be assisted and stabilised by a single or a pair of internal, laterally located gas struts 23 that extend between the compartment 11 and the cover 12. The extensions act like stabilising feet when the cover is up-ended (see FIGS. 8 and 9).

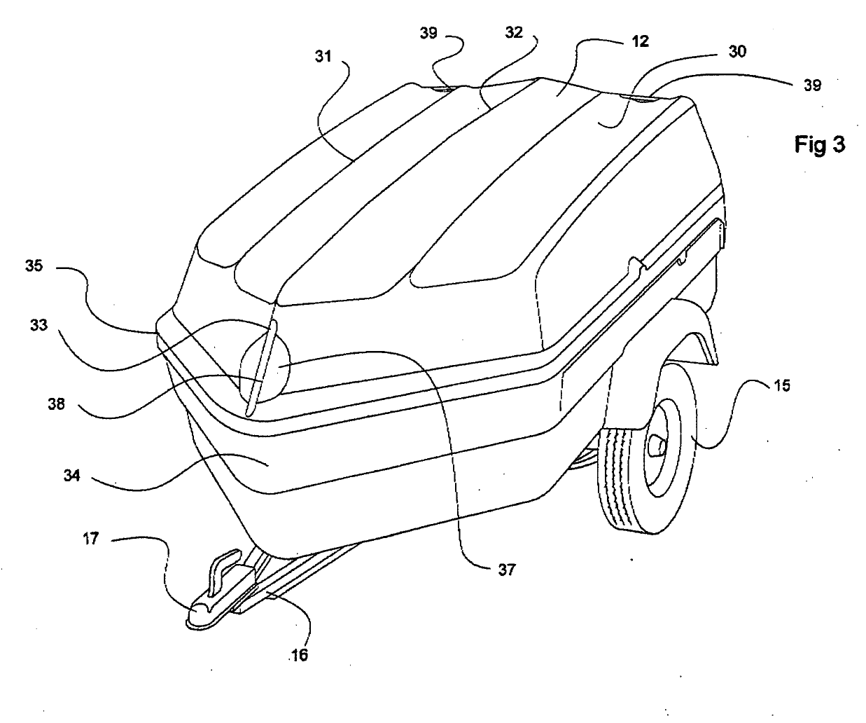

As shown in FIG. 3, the cover 12 has the appearance of a watercraft such as a dingy. In this regard, the cover may optionally include a relatively flat bottom portion 30 with an optional minor longitudinal curve or hydrodynamic rocker 19 that further comprises longitudinal chines 31 as well as a modest central keel 32. The forward portion of the cover 12 comes to an inclined, rounded edge or bow 33 that is generally aerodynamic and hydrodynamic. This rounded frontal shape is mirrored by the similarly shaped prow-like front portion 34 of the compartment that slants rearward toward the compartment's generally parallel sides 18. Note that the cover 12 further comprises a circumferential lip 35 that is able to receive and thus seal the upper edge margin of the container. Thus, water flowing over the closed cover 12 is unable to enter the container 11. As also shown in FIG. 3, the front portion 33 of cover 12 further comprises a depression or recess 37 across which spans a grab handle 38 fastened with rivets at each end. Similarly configured recesses and grab handles 39 are provided along the rear upper edge of the cover 12.

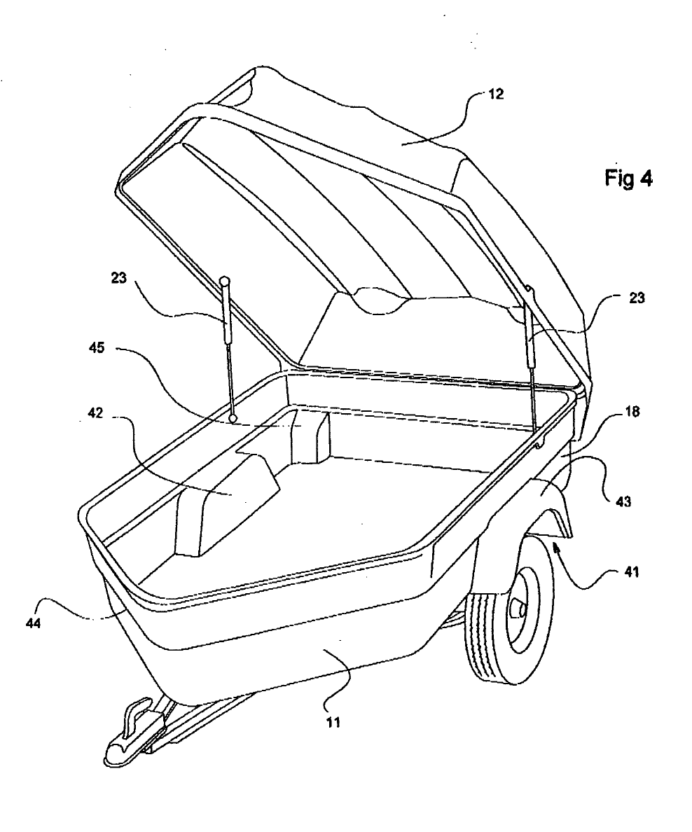

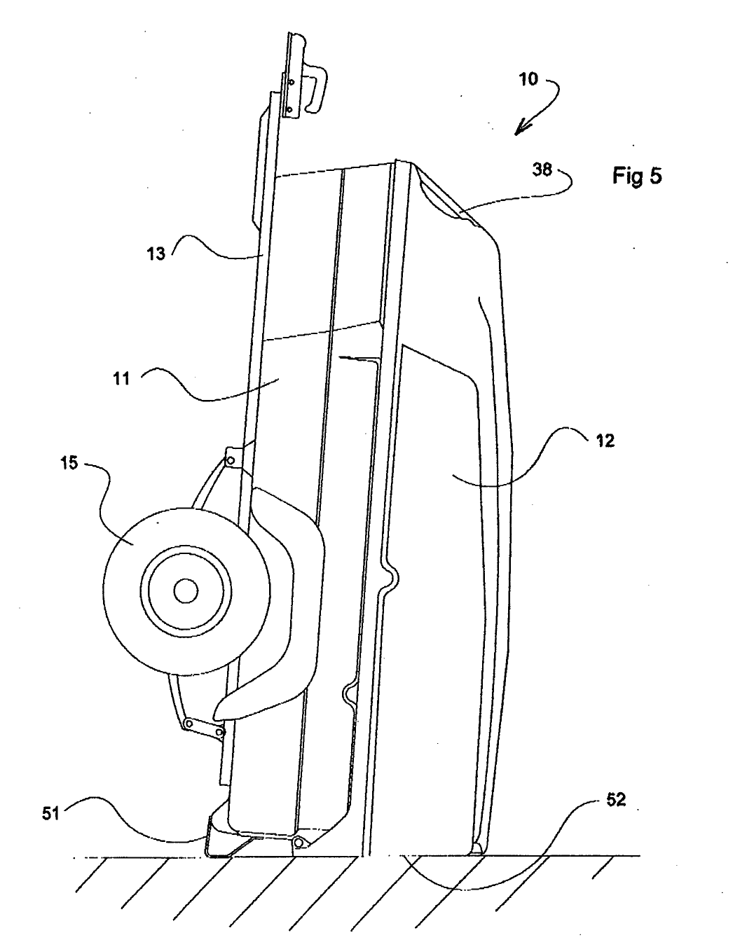

As shown in FIG. 4, the gas strut or struts 23 are located within the interior space defined by the compartment 11 and the cover 12. As also shown in this view, the wheel wells 41 are defined by a depression or recess 42 formed in the compartment 11, working in combination with an exterior fender component or guard 43 that is affixed to the compartment 11, for example, with an adhesive. The compartment may also have circumferential stiffening ridges 44 as well as recessed portions 45 for receiving the taillights and turn signal indicators.

As shown in FIG. 5, the closed trailer 10 is adapted to rest stably on the flat rear surfaces 51, 52, of the compartment 11 and the surface of cover 12 and the support “overrider” stand 51 at the rear of container 11. In this orientation, additional stability is optionally provided by having the long axis of the “A” shaped frame 13 inclined slightly from an absolutely upright and vertical orientation. In this orientation, the trailer occupies less floor space or “foot print” than when the wheels are in contact with the ground.

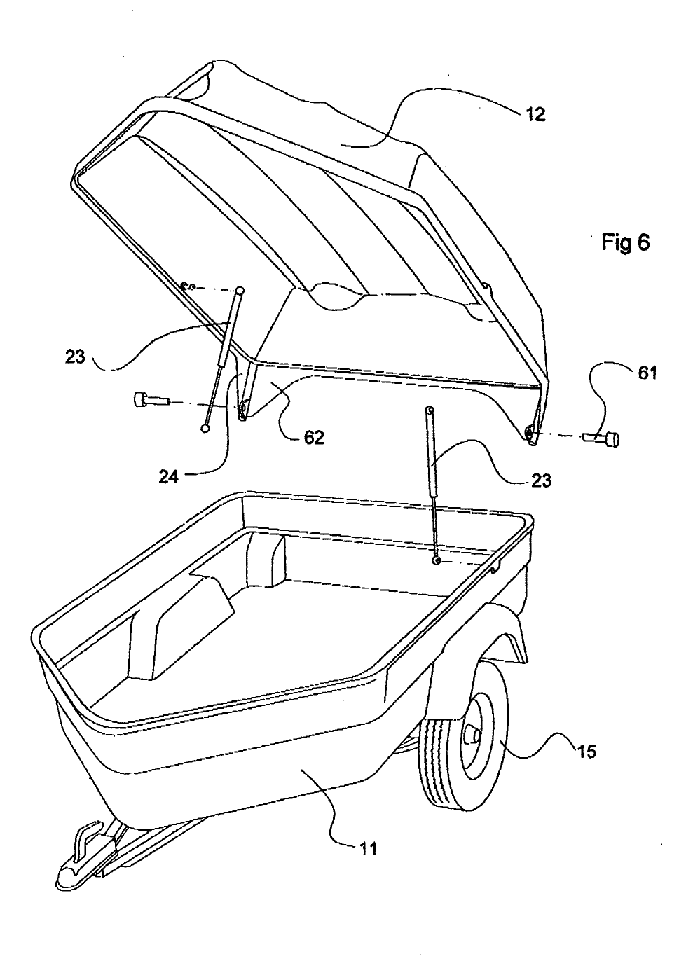

As shown in FIG. 6, the cover 12 is detachable from the compartment 11. A pair of fasteners or pins 61 removably connects the cover 12 to the hinge components of the compartment 11. When these are removed, and the gas strut or struts 23 disconnected (at least from the cover), the cover 12 can be separated from the compartment 11. Once it is separated, the cover 12 can be used for various purposes. The cover 12 may be used as a boat (with or without optional seats) or as a shelving unit, as will be explained below. Note that the extensions 21 advantageously locate the hinge axis below the plane of the seal between the compartment and the cover. In this example, the tabular metal extensions 21 are reinforced by lateral 24 and transverse 62 gussets or webs.

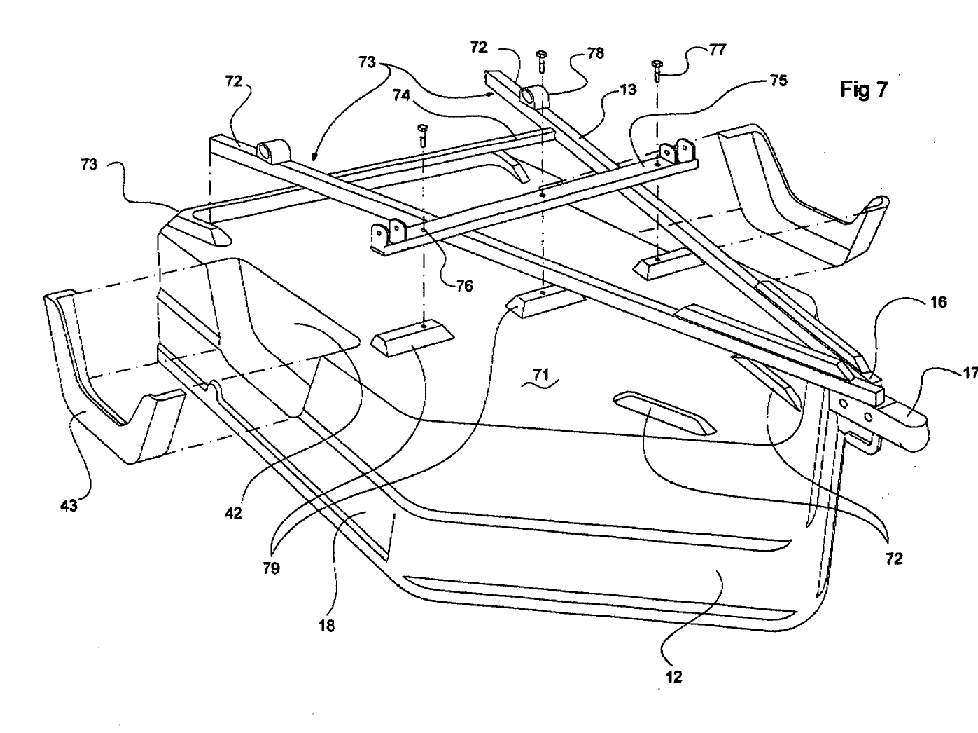

As shown in FIG. 7, the upper side of the “A” shaped frame 13 is fastened to the underside of the compartment 12. Note that the underside 71 of the compartment 12 is generally flat, having certain features integrally formed and rising above the otherwise flat surface. A front portion of the underside 71 may be characterised by a pair of guides 72 which locate the forward portion of the frame 13. The rear portion of the legs 72 of the frame 13 are located by an upwardly extending ridge 73 that also serves to reinforce and stiffen the lower back edge area of the compartment 12. Thus, the two legs 73 of the frame 13 lie generally flat along the bottom 71 of the compartment 12. A rigid cross bar 74 extends between the legs, toward the rear to add strength to the compartment 12. A suspension bracket or bar 75 is located transversely of the “A” frame and may be either is integral with the “A” frame it or provided separately. It has through apertures 76 through which pass mechanical fasteners 77 that screw into metal formers within the embossed features 79, which are “match drilled and threaded” to the “A” frame captive nuts to assist in the location and retention of the “A” frame to the compartment 12. A permanent industrial adhesive bond preferably secures the “A” frame 13 to the under side of the compartment 12. Note that each leg carries a rear suspension bracket, bushings or fixings 78 that is located on the underside of each leg between the rear terminal end and the cross bar 74.

As shown in FIG. 8, the cover 12, when up-ended and resting on its flat rear surface 52 may serve as the outer shell of a shelving unit. The shelving unit comprises the upturned cover 12 together with removable horizontal shelves 81. In this example, three shelves are shown as having been inserted into corresponding brackets located within the cover 12. Note the stabilising effect provided the reinforced extensions 21.

As shown in FIG. 9, the shelves 81 are generally shaped to conform to the internal dimensions of the cover 12. Optional lateral shelf brackets, pegs or protrusions or slots 91 may be used along with or in combination with a wide variety of fixtures for retaining the removable shelves 81. The shelves are useful when the cover is up-ended.

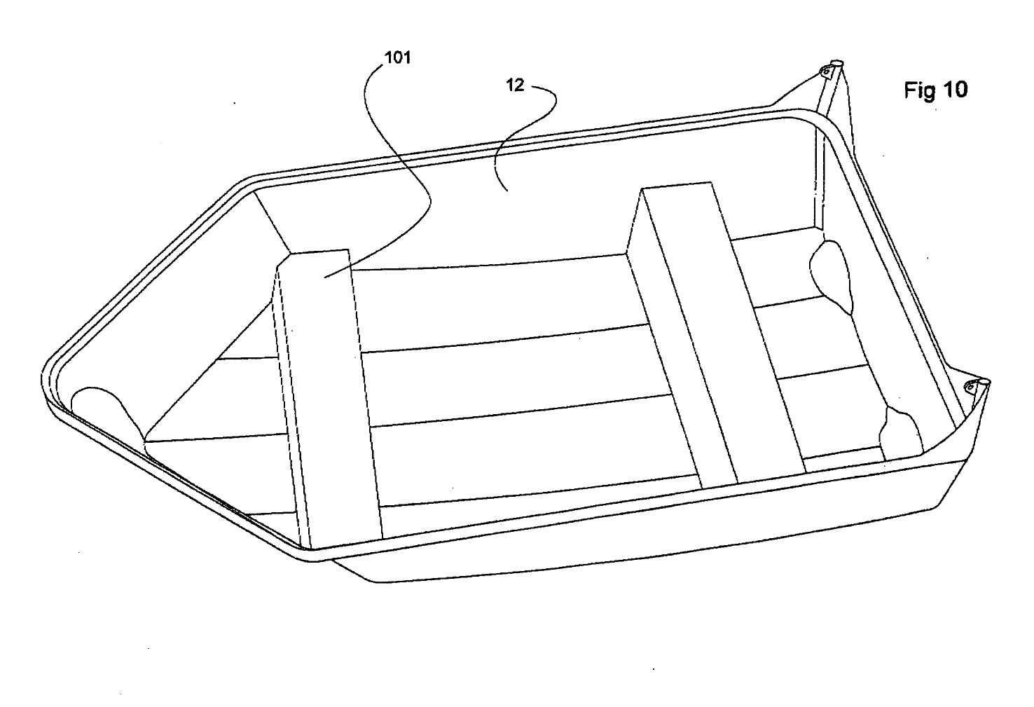

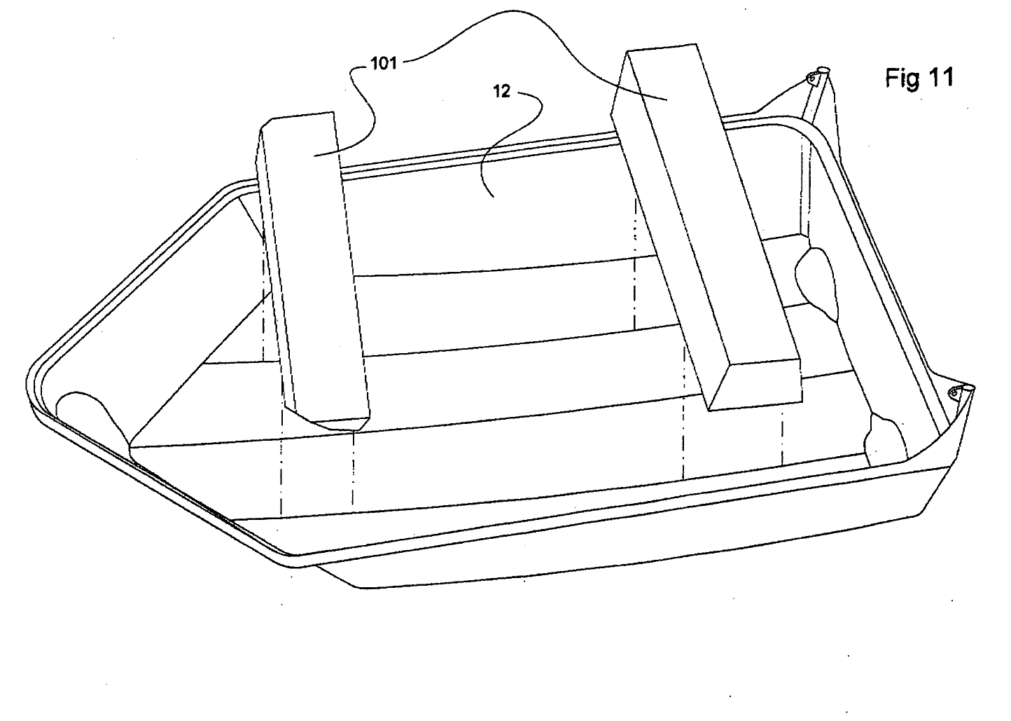

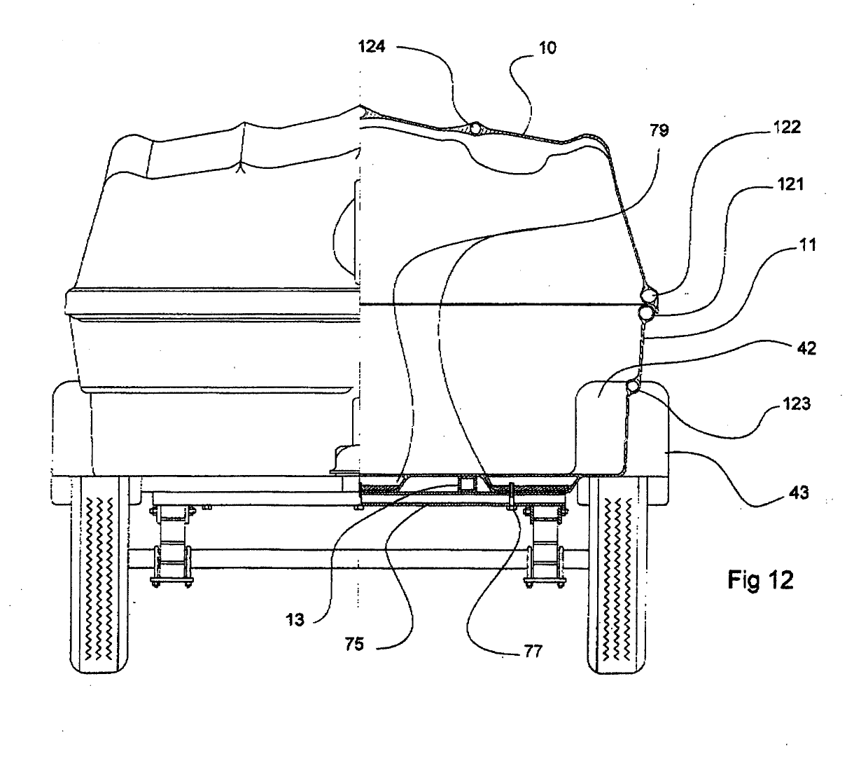

As shown in FIGS. 10 and 11, the cover 12 may be used as a watercraft. As such, it may be provided with removable bench type seats 101, preferably filled with buoyant foam. In preferred embodiments, the bench seats 101 extend between the sides of the cover 12 and may be affixed to the interior of the cover 12 utilising friction, fasteners or even adhesives, as required.

As shown in FIG. 12 metallic tubular components 92 may be used as structural components of the ground-contacting surface of the up-turned shelf 12. These components 92 are located along the rear corners 93 and may extend the full length of the extensions 24, these components form part of the hinge providing strength and stability to the cover. Tubular components 121, 122, 123, 124 may also be used as embedded reinforcement to other parts of the compartment or and cover as required to provide rigidity and shape retention. As shown in FIG. 12, tubular reinforcement is used in the peripheral rims of the compartment 121, the rim of the cover 122, in the peripheral walls 123 of the compartment 11, and longitudinally along the top of the cover 124.

While the present invention has been described with reference to particular details of construction, these should be understood as having been provided by way of example and not as limitations to the scope of spirit or the invention.

What is claimed is:

1. A trailer, comprising:
an “A” shaped frame above which is located a trailer compartment;
the “A” shaped frame further comprising a pair of straight legs that extend rearward from an apex adjacent a coupling mechanism the legs being secured to and supporting substantially the entire length of the compartment:
the compartment having sides and a front portion that slants rearward toward the sides.

2. The trailer of claim 1, wherein:
the sides each further comprise a recess defining at least a portion of a wheel well.

3. The trailer of claim 1, wherein:
the legs are adhered to an underside of the compartment.

4. The trailer of claim 3, wherein:
the underside has protruding features that locate the position of the frame.

5. The trailer of claim 1, wherein:
the frame further comprises a transverse suspension bracket to which one end of each of a pair of springs is attached.

6. The trailer of claim 5, wherein:
the frame has a pair of legs, each carrying fixings located between the bracket and a leg terminal end for carrying a rear portion of the springs.

7. The trailer of claim 5, wherein:
the bracket is affixed to the compartment by fasteners that pass through the bracket and into raised portions of an underside of the compartment that support the bracket.

8. A trailer having a trailer compartment and a ridged cover, comprising:
a frame above which is located a trailer compartment having sides that come to a prow-like front portion;
the compartment and cover have rear ends that cooperate so that the trailer can rest stably when up-ended:
the cover cooperating with the compartment to seal it when the cover is closed.

9. (canceled)

10. The trailer of claim 8, wherein:
the cover has rear extensions that carry hinge components, the hinge components cooperating with hinge components carried by the compartment; the extensions acting as stabilising feet when the cover is up-ended.

11. The trailer of claim 8, further comprising:
removable seats that allow the cover to be used as a watercraft.

12. The trailer of claim 8, wherein:
the cover has sides having an interior surface that is characterised with one or more pairs of shelf brackets for carrying transverse shelves when the cover is up-ended.

13. The trailer of claim 8, wherein:
the cover further comprises one or more depressions that are spanned by grab handles.

14. The trailer of claim 8, wherein:
at least one gas strut extends between the compartment and the trailer cover and the gas strut is disconnectable from the cover.

15. The trailer of claim 8, wherein:
the cover has hydrodynamic features, comprising at least longitudinal chines that adapt it to use as a watercraft.

16. The trailer of claim 10, wherein:
the cover comprises tubular metal reinforcing inserts, at least along the length of the extensions.

17. The trailer of claim 10, wherein:
the compartment has an upper edge and the cover has a lower edge that surrounds the upper edge of the compartment when the cover is closed.

18. The trailer of claim 10, wherein:
the compartment has an upper edge and the cover has a lower edge, the edges cooperating to form a sealing plane;
the compartment and the cover being hinged together, at least temporarily, by hinge components that are located below the sealing plane.

19. The trailer of claim 8, wherein:
the cover, when disconnected from the compartment can act as a watercraft or as a shell for shelves.

20. The trailer of claim 10, wherein:
both the compartment and cover are polymer based and the frame is metal.
